(19) United States
(12) Patent Application Publication
(10) Pub. No.: US 2009/0055186 A1
(43) Pub. Date: Feb. 26, 2009

(54) METHOD TO VOICE ID TAG CONTENT TO EASE READING FOR VISUALLY IMPAIRED

(75) Inventors: John M. Lance, Littleton, MA (US); Tolga Oral, Winchester, MA (US); Andrew L. Schirmer, Andover, MA (US); Anuphinh P. Wanderski, Durham, NC (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/843,714

(22) Filed: Aug. 23, 2007

(51) Int. Cl. G10L 13/00

(52) U.S. Cl. 704/260

(57) ABSTRACT

A method for providing information to generate distinguishing voices for text content attributable to different authors includes receiving a plurality of text sections each attributable to one of a plurality of authors; identifying which author authored each text section; assigning a unique voice tag id to each author; associating a distinct set of descriptive metadata with each unique voice tag id; and generating a set of speech information for each text section. The set of speech information generated for each text section is based upon the distinct set of descriptive metadata associated with the unique voice tag id assigned to the corresponding author of the text section. The set of speech information generated for each text section is configured to be used by a speech synthesizer to translate the text section into speech in a distinguishing computer-generated voice for the author of the text section.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to assistive technology, and more particularly to applications providing text-to-voice conversion of cooperative content.

2. Description of Background

Screen readers are a form of assistive technology (AT) developed for people who are blind, visually impaired, or learning disabled, often in combination with other AT such as screen magnifiers. A screen reader is a software application or component that attempts to identify and interpret what is being displayed on the screen. This interpretation is then represented to the user using text-to-speech, sound icons, or a Braille output. Although the term “screen reader” suggests a software program that actually “reads” a computer display, a screen reader does not read characters or text displayed on a computer monitor. Rather, a screen reader interacts with the display engine of a computer or directly with applications to determine what is to be spoken to a user (for example, via the computer system's speakers).

Using information obtained from a display engine or an application, a screen reader determines what is to be communicated to a user. For example, upon recognizing that a window of an application has been brought into focus, the screen reader can announce the window's title. When the screen reader recognizes that a user has tabbed into a text field in the application, it can audibly indicate that the text field is the current focus of the application, as well as speak an associated label for that text field. A screen reader will typically also include a text-to-speech synthesizer, which allows the screen reader to determine what text needs to be spoken, submit speech information with the text to the text-to-speech synthesizer, and thereby cause audible words to be generated from the computer's audio system in a computer-generated voice. A screen reader may also interact with a Braille display that is peripherally attached to a computer.

Screen readers can be assumed to be able to access all display content that is not intrinsically inaccessible. Web browsers, word processors, icons, windows, and email programs have been used successfully by screen reader users. Using a screen reader, however, can still be considerably more difficult than using a GUI, and the nature of many applications can result in application-specific problems.

One category in which the use of a screen reader can result in difficulties for users is that of applications providing for cooperative content, that is, collaborative or social software. Collaborative software is designed to help people involved in a common task achieve their goals and forms the basis for computer supported cooperative work. Social software refers to communication and interactive tools used outside the workplace, such as, for example, online dating services and social networks like MySpace. Software systems that provide for email, instant messaging chat, web conferencing, internet forums, blogs, calendaring, wikis, etc. belong in this category.

In these types of cooperative environments, the main function of the participants' relationship is to alter a collaboration entity. Examples include the development of a discussion, the creation of a design, and the achievement of a shared goal. Therefore, cooperative applications deliver the functionality for many participants to augment a common deliverable. For visually impaired people, however, screen readers that read the content provided by these applications can operate to mask the cooperative nature of the applications by representing all text contributions from more than one user with the same voice.

For example, when more than two users are participating in an instant messaging session over a network in real time, the session can become convoluted due to multiple user messages, or chats, being sent without any meaningful control over the order in which the chats are posted. A first user may prompt a second user to answer a question. Before the second user answers, however, a third user may post a chat to a fourth user. Thus, as comments, questions, and responses are exchanged, it becomes exceedingly difficult for a person accessing the application through a screen reader to follow the conversation and track comments made by specific participants.

### SUMMARY OF THE INVENTION

The shortcomings of the prior art can be overcome and additional advantages can be provided through exemplary embodiments of the present invention that are related to a method for providing information to generate distinguishing voices for text content attributable to different authors. The method comprises receiving a plurality of text sections each attributable to one of a plurality of authors; identifying which author of the plurality of authors authored each text section of the plurality of text sections; assigning a unique voice tag id to each author of the plurality of authors; associating a distinct set of descriptive metadata with each unique voice tag id; and generating a set of speech information for each text section of the plurality of text sections. The set of speech information generated for each text section is based upon the distinct set of descriptive metadata associated with the unique voice tag id assigned to the corresponding author of the text section. The set of speech information generated for each text section is configured to be used by a speech synthesizer to translate the text section into speech in a distinguishing computer-generated voice for the author of the text section.

The shortcomings of the prior art can also be overcome and additional advantages can also be provided through exemplary embodiments of the present invention that are related to computer program products and data processing systems corresponding to the above-summarized method are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that can be implemented to allow an application providing text-to-voice conversion of cooperative content to read content from different users in distinguishing voices by associating the content with voice tag IDs.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a block diagram illustrating an exemplary embodiment of a system for managing network communications.

FIG. 2 is a block diagram illustrating an exemplary embodiment of a system for text-to-voice conversion of cooperative content providing for different characteristic voices when reading content from different users.

FIG. 3 is a block diagram illustrating an exemplary embodiment of a voice tag ID repository.

FIG. 4 is a block diagram illustrating an exemplary embodiment of a hardware configuration for a computer system.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention.

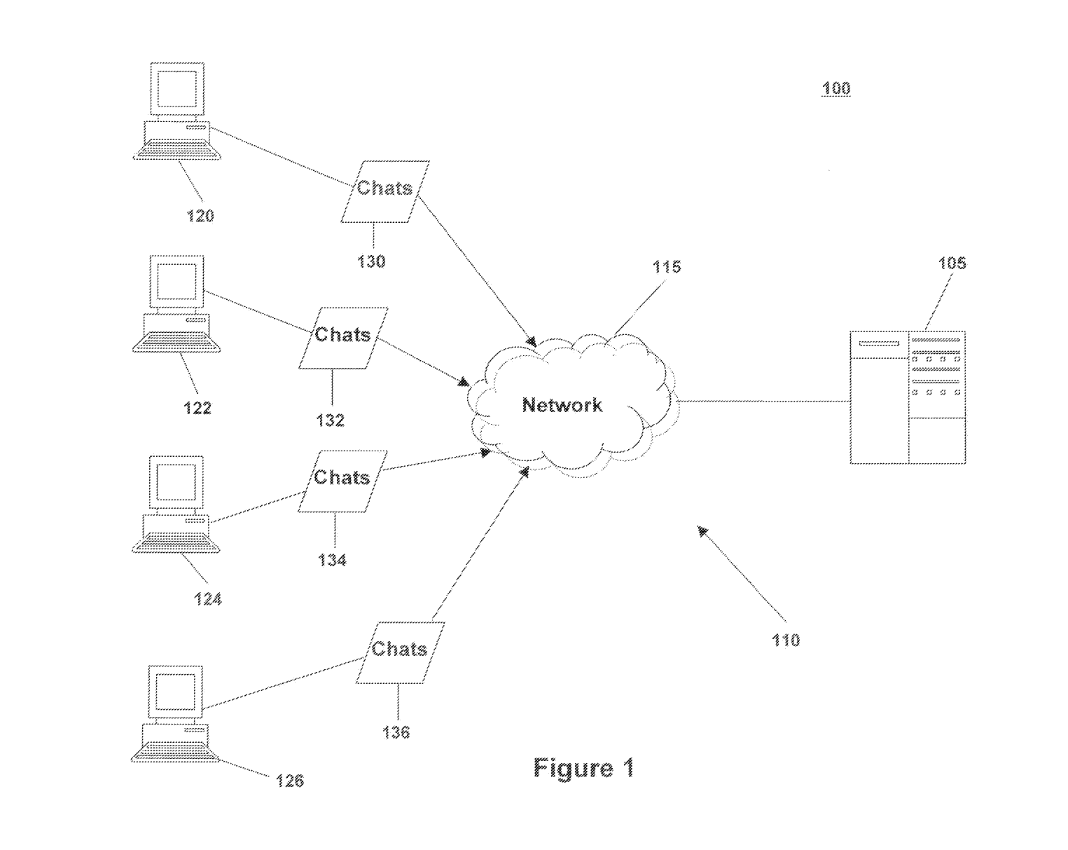

Turning now to the drawings in greater detail, it will be seen that FIG. 1 is a block diagram illustrating an exemplary embodiment of a system, indicated generally at 100, for managing network communications in a cooperative application environment. System 100 can include at least a first application server 105. Application server 105 can be configured to, for example, host chat sessions such as a chat session 110, via a communications network 115. Communications network 115 can be, for example, local area network (LAN), a wide area network (WAN), the Internet, a cellular communications network, or any other communications network over which application server 105 can host chat session 110.

In the present exemplary embodiment, system 100 also includes a first client or user system 120 and one or more additional user systems 122, 124, 126 communicatively linked to first application server 105. Systems 120, 122, 124, 126 can be, for example, computers, mobile communication devices, such as mobile telephones or personal digital assistants (PDAs), network appliances, gaming consoles, or any other devices which can communicate with application server 105 through communications network 115. Systems 120, 122, 124, 126 can thereby generate and post chat messages 130, 132, 134, 136 respectively to chat session 110 hosted on application server 105.

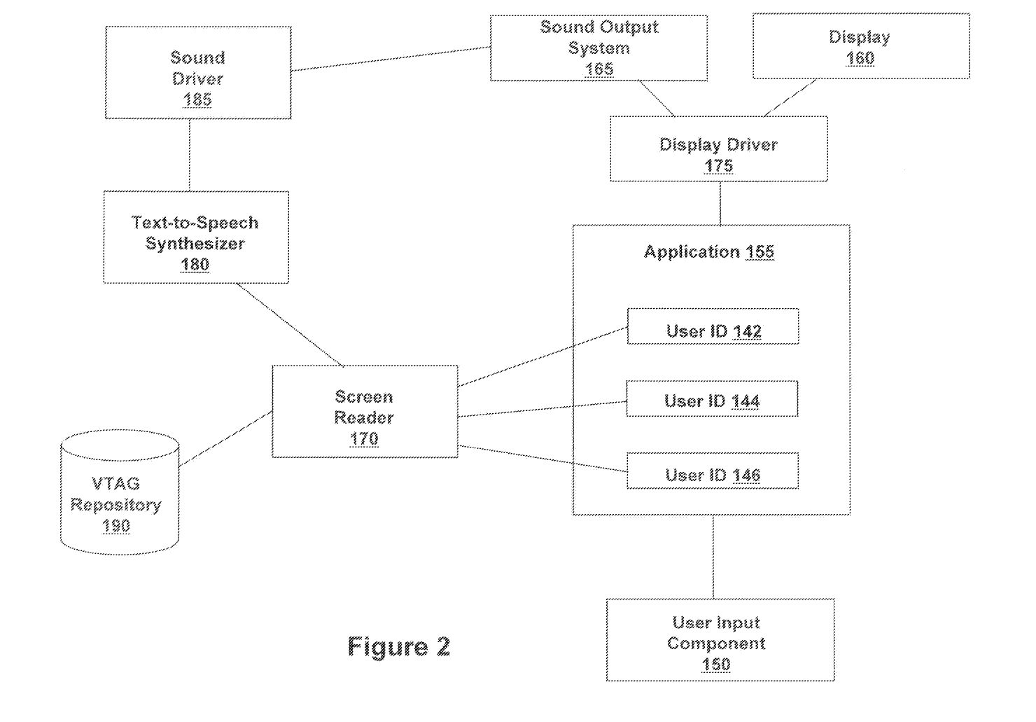

In the exemplary embodiment illustrated in FIG. 1, user system 120 is a computer system that is configured to provide text-to-voice conversion to a user who is a blind, visually impaired, or learning disabled person. In accordance with the present invention, FIG. 2 illustrates an exemplary embodiment of such a system.

As illustrated in FIG. 2, system 120 includes a user input component 150 that is implemented to receive user input from user input devices (not shown), such as, for example, a keyboard, mouse, or the like. User input component 150 is used to interact with a user application 155 such that inputs to the user application are received through the user input component. Outputs from user application 105 are communicated to the user through a display 160 (for example, monitor, Braille display, etc.) and speakers of a sound output system 165. In exemplary embodiments, user application 155 can be a typical software application in accordance with any requirement or activity of the user (for example, email application, Web browser, word processor, or the like) in which cooperative content is provided as output to display 160.

For purposes of discussion, user application 155 will be described in the present exemplary embodiment as an instant messaging application connecting system 120 to chat session 110 over network 115. Nevertheless, it should be noted that exemplary embodiments of the present invention are not limited with respect to the type of application software implemented as user application 155.

In the present exemplary embodiment, a screen reader component 170 is used to translate selected portions of the output of user application 155 into a form that can be rendered as audible speech by the sound system output 165. In exemplary embodiments, screen reader component 170 can be a screen reader software module that is implemented within system 120 as a “display driver,” such as IBM Screen Reader/2. At that level of the operating system software (not shown), it can inspect interaction occurring between the user and system 120, and has access to any information being output to display 160. For instance, user application 155 provides this information as it is making calls to the operating system. In exemplary embodiments, screen reader component 170 may separately query the operating system or user application 155 for what is currently being displayed and receive updates when display 160 changes.

Generally, in the present exemplary embodiment, user application 155 functions to receive as input chat messages 130 from user input component 150 and chat messages 132, 134, 136 from systems 122, 124, 126 from application server 105 through network 115. User application 155 acts upon the received input chat messages and generates the corresponding output functionality by posting these chat message inputs to display 160. This output functionality can take the form of, for example, graphical presentations or alphanumeric presentations for display 160 or audible sound output for sound system output 165. Display driver 175 provides the electronic signals required to drive images on to display 160 (for example, a CRT monitor, Braille display, etc.). As user application 155 posts chat messages 130, 132, 134, 136 to display 160, the chat messages are also accessed by the screen reader component 170 and a display driver 175.

The display presentations provided to screen reader component 170 from user application 155 are used by the screen reader component to generate speech information for producing audible text to be heard by the user. Screen reader component 170 generates a resulting output with this speech information and sends this output to a text-to-speech synthesizer 180. Text-to-speech synthesizer 180 converts normal language text of the speech information into artificial speech and generates the audible text output through a sound driver 185 coupled to output sound system 165. Thus, in the present exemplary embodiment, the outputs of text-to-speech synthesizer 180 are in the form of computer-generated voices. Text-to-speech synthesizer 180 can, for example, use SAPT4- and SAPI5-based speech systems that include a speech recognition engine. Alternatively, text-to-speech synthesizer 180 can use a speech system that is integrated into the operating system or a speech system that is implemented as a plug-in to another application module running on system 120.

In the present exemplary embodiment, system 120 utilizes a voice tagging technique to identify content attributed to particular “authors” within cooperative user application 155 so that screen reader component 170 can produce speech information that can be used to generate distinguishing voices for chat messages from different users. The use of distinguishing voices can provide quicker clues to blind or visually impaired users of system 120 without requiring the overhead of additional descriptive output identifying the specific system or user from which each chat message originated.

In exemplary embodiments, “authorship” in this sense can be determined by examining additional context or metadata for the content as specified by the specific type of application software implemented as user application 155 in one of many common ways. For instance, “authorship” can be determined according to the “Author” field in a word processing document, the “From” in an email message, usernames in an instant messaging chat sessions, or by using a software component configured to intelligently parse “conversational” text such as an email thread having a chain of embedded replies in which changes were made to an original email's content in a reply to identify the most recent editor of the original content. Nonetheless, it should be noted that the invention is not limited with respect to the manner in which “authorship” is determined. Indeed, authorship can be determined in any other suitable manner.

In the present exemplary embodiment, user application 155 determines the “authorship” of posted chat messages 132, 134, 136 as they are received, and then associates each chat message with a user identifier stored within the running application. For instance, user application 155 can include a chat session list correlating chat messages posted from systems 122, 124, 126 with user identifiers 142, 144, and 146, as shown in FIG. 2. The chat session list can comprise a data table, a text file, or any other data file suitable for storing the user identifiers.

As screen reader component 170 accesses chat messages when they are posted to display 160 by user application 155, the screen reader component is configured to generate speech information associating a distinguishing, characteristic voice with content provided from each of user identifiers 142, 144, and 146. For example, a woman's voice might be associated with user identifier 142, a man's voice might be associated with user identifier 144, and a lower-pitched man's voice might be associated with user identifier 146. Screen reader component 170 operates to do so by associating a descriptive context, or metadata, with the content provided by each distinct user identifier that provides the distinguishing characteristics of each voice.

For purposes of this disclosure, the term “voice ID tag”, or VTAG, is used herein to describe specific metadata attributes that are used in generating a distinguishing voice for a specific user identifier. Metadata is structured, encoded data that describe characteristics of information-bearing entities to aid in the identification, discovery, assessment, and management of the described entities. That is, metadata provide information (data) about a particular content (data). VTAGs could include information specifying speech characteristics according to, for example, pitch, tone, volume, gender, age group, cadence, general accent associated with a geographical location (for example, English, French, or Russian accents), etc. that can be used to select a computer-generated voice based upon these characteristics. It should be noted that these characteristics are merely non-limiting examples of what types of information can be included in VTAGs, and therefore, many other types of information could be specified within VTAGs and used to generate characteristic voices for specific users. In exemplary embodiments, metadata of a VTAG could be derived in content created by the specific user associated with a user identifier, specified by the user of the application providing speech information, or derived according to any number of many other characteristics.

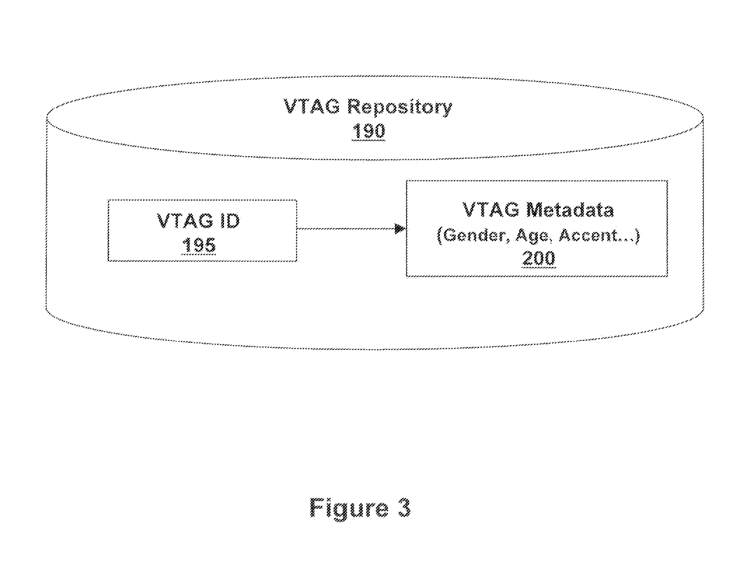

Screen reader component 170 generates a VTAG for each specific user identifier and stores each of these VTAGs as a software object in a VTAG repository 190. In the present exemplary embodiment, VTAG objects could be stored as directory entries according to the Lightweight Directory Access Protocol, or LDAP, and VTAG repository 190 could be implemented as an LDAP directory, as illustrated in FIG. 3. LDAP is an application protocol for querying and modifying directory services running over TCP/IP. LDAP directories comprise a set of objects with similar attributes organized in a logical and hierarchical manner as a tree of directory entries. Each directory entry has a unique identifier 195 (here, a VTAG ID associated with a specific user identifier) and consists of a set of attributes 200 (here, VTAG metadata describing a distinguishing voice for each VTAG ID). The attributes each have a name and one or more values, and are defined in a schema.

During operation of the present exemplary embodiment, screen reader component 170 initiates an LDAP session by connecting to VTAG repository 190, sending operation requests to the server, and receiving responses sent from the server in return. Screen reader component 170 can search for and retrieve VTAG entries associated with specific user identifiers, compare VTAG metadata attribute values, add new VTAG entries for new user identifiers, delete VTAG entries, modify the attributes of VTAG entries, import VTAG entries from existing databases and directories, etc.

In exemplary embodiments, by binding distinctive characteristics of a particular voice with a particular user entry in an LDAP directory (or within an alternative data model or directory type), screen reader component 170 can associate the particular distinct voice with content submitted or posted by a specific user so that it can be used consistently whenever metadata identifying that user is detected. That is, once the VTAG ID or the identity of the user is discovered, the application accessing the directory or data model can retrieve VTAG metadata to use with voice-generating software.

In exemplary embodiments, native support for text-to-voice synthesis may be incorporated within user application 155, in which case the user application is already configured to output computer-generated voice representations of the content it receives. For these situations, screen reader component 170 can be configured to operate by accessing the content as it is received by user application 155, and then embed the received content with the VTAG IDs created for the corresponding user identifiers as metadata. User application 155 can then use the embedded VTAG IDs “tagged” with the content in this fashion to obtain the corresponding VTAG metadata specifying the voice characteristics by connecting to and directly accessing VTAG repository 190. The content is then used with the corresponding VTAG metadata by the text-to-voice synthesizer provided within user application 155 to generate the distinguishing voices associated with the VTAG IDs for content originating from separate users.

In alternative exemplary embodiments, the option of connecting to VTAG repository 190 to obtain VTAG metadata associated with a VTAG ID may not be available to user application 155 (for example, where a first user sends an email message from an IBM domain to a second user in a Microsoft domain). In these instances, screen reader component 170, rather than embedding the received content with the VTAG IDs created for the corresponding user identifiers as metadata, can be configured to embed content within user application 155 with the full VTAG metadata set for the corresponding user identifiers. The content, “tagged” with the corresponding VTAG metadata in this fashion, is then used by the text-to-voice synthesizer provided within user application 155 to generate the distinguishing voices associated with the VTAGs for content originating from separate users.

Therefore, in varying exemplary embodiments, when system 120 runs screen reader component 170 against user application 155, the screen reader component, depending on the type and aspects of the application and the content to be read, could be configured to embed the content with retrieved VTAG IDs within the application, embed the content with retrieved VTAG metadata within the application, or separately drive a text-to-speech synthesizer using the content and VTAG metadata associated with user identifiers provided by the user application, such as, for example, a username or an email address from a common repository. That is, in exemplary embodiments, screen reader component 170 can generate whatever speech information is required to produce audible text in a distinguishing voice according to VTAG metadata to be heard by the user of system 120.

Notably, use of VTAG techniques is not limited to instant messaging applications or systems employing screen reader components as described in the exemplary embodiments above. In exemplary embodiments, VTAG techniques can be incorporated for use with reading cooperative content provided by any of number of software systems, such as, for example, those that provide for email, web conferencing, internet forums, blogs, calendaring, wikis, etc. Also, in exemplary embodiments, the ability to ready VTAG metadata could be incorporated as a component of any other application that is capable of providing text-to-voice conversion (for example, an application that reads email message over a telephone call) just as it can incorporated as a function to a screen reader application. Therefore, exemplary embodiments of the present invention should not be construed as being limited to implementations within configurations that employ screen readers or the like. Rather, exemplary embodiments can be implemented to facilitate the interpretation of content from different users by associating the content with voice tag IDs for use with or as part of any system or component that is configured to provide text-to-voice conversion. For instance, in non-limiting exemplary embodiments, voice tag ID techniques can be implemented directly within a collaborative or social application module, such as user application 155 in the exemplary embodiment described above.

For instance, in exemplary embodiments, VTAG techniques can be implemented to provide a method for voice-tagging email content containing multiple replies such that the text-to-voice conversion of the email facilitates easier understanding and interpretation by a recipient. This could be particularly helpful in situations where changes were made to an original email's content in a reply to the email. By generating distinguishing voices for the original and edited text in the message body, the application would enable the recipient to identify the collaborative or cooperative aspects of the email message, even where the recipient was added to the thread of the email during the course of communication and therefore had not previously received the entire thread of the email.

The capabilities of exemplary embodiments of present invention described above can be implemented in software, firmware, hardware, or some combination thereof, and may be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. Exemplary embodiments of the present invention can also be embedded in a computer program product, which comprises features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

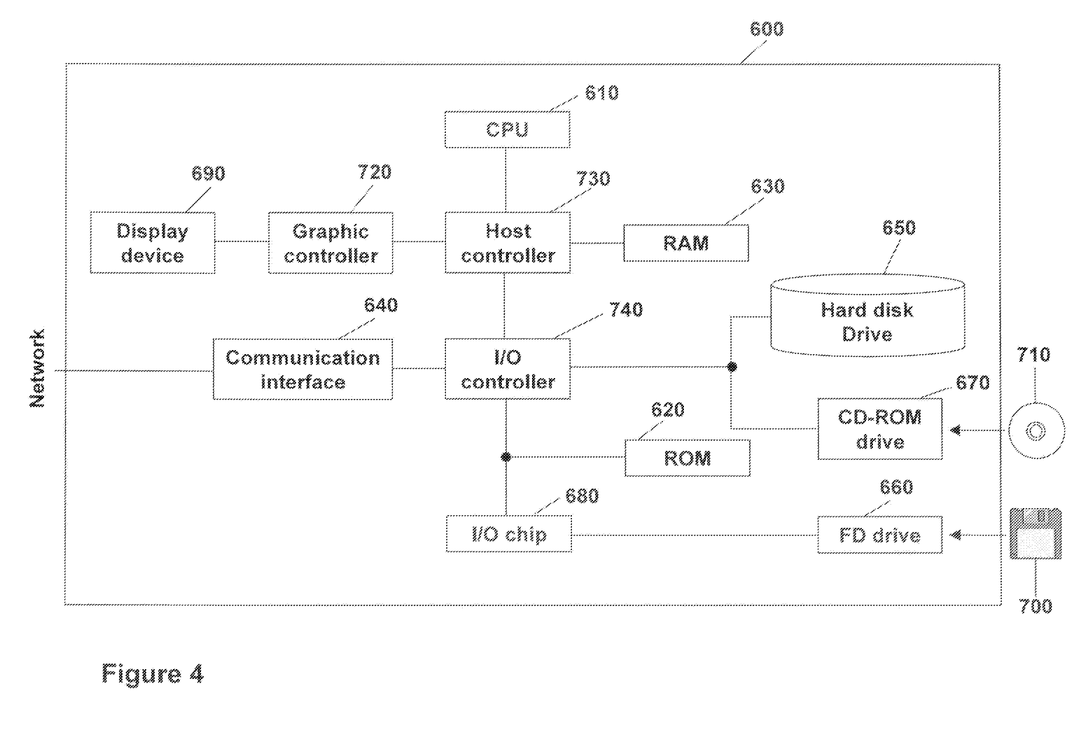

Therefore, one or more aspects of exemplary embodiments of the present invention can be included in an article of manufacture (for example, one or more computer program products) having, for instance, computer usable media. The media has embodied therein, for instance, computer readable program code means for providing and facilitating the capabilities of the present invention. The article of manufacture can be included as a part of a computer system or sold separately. Furthermore, at least one program storage device readable by a machine, tangibly embodying at least one program of instructions executable by the machine to perform the capabilities of the exemplary embodiments of the present invention described above can be provided. To illustrate, FIG. 4 shows a block diagram of an exemplary embodiment of a hardware configuration for a computer system, representing system 120 in FIG. 2, through which exemplary embodiments of the present invention can be implemented.

As illustrated in FIG. 4, computer system 600 includes: a CPU peripheral part having a CPU 610 that accesses a RAM 630 at a high transfer rate, a display device 690, and a graphic controller 720, all of which are connected to each other by a host controller 730; an input/output part having a communication interface 340, a hard disk drive 650, and a CD-ROM drive 670, all of which are connected to host controller 730 by an input/output controller 740; and a legacy input/output part having a ROM 620, a flexible disk drive 660, and an input/output chip 680, all of which are connected to input/output controller 740.

Host controller 730 connects RAM 630, CPU 610, and graphic controller 720 to each other. CPU 610 operates based on programs stored in ROM 620 and RAM 630, and controls the respective parts. Graphic controller 720 obtains image data created on a frame buffer provided in RAM 630 by CPU 610 and the like, and displays the data on the display device 690. Alternatively, graphic controller 720 may include a frame buffer that stores image data created by CPU 610 and the like therein.

Input/output controller 740 connects host controller 730 to communication interface 640, hard disk drive 650, and CD-ROM drive 670, which are relatively high-speed input/output devices. Communication interface 640 communicates with other devices through the network. Hard disk drive 650 stores programs and data that are used by CPU 610 in computer 600. CD-ROM drive 670 reads programs or data from CD-ROM 710 and provides the programs or the data to hard disk drive 650 through RAM 630.

Moreover, ROM 620, flexible disk drive 660, and input/output chip 680, which are relatively low-speed input/output devices, are connected to input/output controller 740. ROM 620 stores a boot program executed by computer 600 at its start, a program dependent on the hardware of the computer, and the like. Flexible disk drive 660 reads programs or data from flexible disk 700 and provides the programs or the data to hard disk drive 650 through RAM 630. Input/output chip 680 connects the various input/output devices to each other through flexible disk drive 660 and, for example, a parallel port, a serial port, a keyboard port, a mouse port and the like.

The programs provided to hard disk drive 650 through RAM 630 are stored in a recording medium such as flexible disk 700, CD-ROM 710, or an IC card. Thus, the programs are provided by a user. The programs are read from the recording medium, installed into hard disk drive 650 in computer 600 through RAM 630, and executed in CPU 610.

The above-described program or modules implementing exemplary embodiments of the present invention can work on CPU 610 and the like and allow computer 600 to “tag” content with VTAG information as described in the exemplary embodiments described above. The program or modules implementing exemplary embodiments may be stored in an external storage medium. In addition to flexible disk 700 and CD-ROM 710, an optical recording medium such as a DVD and a PD, a magneto-optical recording medium such as a MD, a tape medium, a semiconductor memory such as an IC card, and the like may be used as the storage medium. Moreover, the program may be provided to computer 600 through the network by using, as the recording medium, a storage device such as a hard disk or a RAM, which is provided in a server system connected to a dedicated communication network or the Internet.

Although exemplary embodiments of the present invention have been described in detail, it should be understood that various changes, substitutions and alternations can be made therein without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A method for providing information to generate distinguishing voices for text content attributable to different authors, the method comprising:
receiving a plurality of text sections each attributable to one of a plurality of authors;
identifying which author of the plurality of authors authored each text section of the plurality of text sections;
assigning a unique voice tag id to each author of the plurality of authors;
associating a distinct set of descriptive metadata with each unique voice tag id; and
generating a set of speech information for each text section of the plurality of text sections, the set of speech information generated for each text section being based upon the distinct set of descriptive metadata associated with the unique voice tag id assigned to the corresponding author of the text section, the set of speech information generated for each text section being configured to be used by a speech synthesizer to translate the text section into speech in a distinguishing computer-generated voice for the author of the text section.

2. The method of claim 1, wherein the author of each text section is identified by examining a set of context information for the plurality of text sections.

3. The method of claim 1, wherein the author of each text section is identified by a software component configured to intelligently parse the plurality of text sections.

4. The method of claim 2, wherein the distinct set of descriptive metadata associated with each unique voice tag id is determined according to content within the set of context information for the plurality of text sections that was created by the author to which the unique voice tag id was assigned.

5. The method of claim 1, wherein each distinct set of descriptive metadata includes information specifying speech characteristics according to pitch, tone, volume, gender, age group, cadence, accent associated with a geographical location, and combinations thereof.

6. The method of claim 1, further comprising storing each unique voice tag id and its associated distinct set of descriptive metadata as a voice tag object in a LDAP directory.

7. The method of claim 1, further comprising sending each set of speech information to the speech synthesizer.

8. The method of claim 1, wherein assigning a unique voice tag id to each author of the plurality of authors, associating a distinct set of descriptive metadata with each unique voice tag id, and generating a set of speech information for each text section of the plurality of text sections is performed by a screen reader module.

9. The method of claim 1, wherein receiving the plurality of text sections each attributable to one of the plurality of authors, and identifying which author of the plurality of authors authored each text section are performed by a cooperative software application module configured to send the plurality of text sections as output to a display engine.

10. The method of claim 6, wherein assigning a unique voice tag id to each author of the plurality of authors, associating a distinct set of descriptive metadata with each unique voice tag id, and storing each unique voice tag id and its associated distinct set of descriptive metadata as a voice tag object in a LDAP directory is performed by a screen reader module, and wherein generating a set of speech information for each text section of the plurality of text sections is performed by the cooperative software application module.

11. The method of claim 10, wherein the cooperative software application module, when generating a set of speech information for each text section of the plurality of text sections, obtains the unique voice tag id assigned to the author of the text section from the screen reader and access the LDAP directory to obtain the distinct set of descriptive metadata associated with the unique voice tag id obtained from the screen reader.

12. The method of claim 10, wherein the cooperative software application module, when generating a set of speech information for each text section of the plurality of text sections, obtains the distinct set of descriptive metadata associated with the unique voice tag id assigned to the author of the text section from the screen reader.

13. A computer-usable medium having computer readable instructions stored thereon for execution by a computer processor to perform a method for providing information to generate distinguishing voices for text content attributable to different authors, the method comprising:
receiving a plurality of text sections each attributable to one of a plurality of authors;
identifying which author of the plurality of authors authored each text section of the plurality of text sections;
assigning a unique voice tag id to each author of the plurality of authors;
associating a distinct set of descriptive metadata with each unique voice tag id; and
generating a set of speech information for each text section of the plurality of text sections, the set of speech information generated for each text section being based upon the distinct set of descriptive metadata associated with the unique voice tag id assigned to the corresponding author of the text section, the set of speech information generated for each text section being configured to be used by a speech synthesizer to translate the text section into speech in a distinguishing computer-generated voice for the author of the text section.

14. A data processing system comprising:
a central processing unit;
a random access memory for storing data and programs for execution by the central processing unit;
a first storage level comprising a nonvolatile storage device; and
computer readable instructions stored in the random access memory for execution by central processing unit to perform a method for providing information to generate distinguishing voices for text content attributable to different authors, the method comprising:
receiving a plurality of text sections each attributable to one of a plurality of authors;
identifying which author of the plurality of authors authored each text section of the plurality of text sections;
assigning a unique voice tag id to each author of the plurality of authors;
associating a distinct set of descriptive metadata with each unique voice tag id; and
generating a set of speech information for each text section of the plurality of text sections, the set of speech information generated for each text section being based upon the distinct set of descriptive metadata associated with the unique voice tag id assigned to the corresponding author of the text section, the set of speech information generated for each text section being configured to be used by a speech synthesizer to translate the text section into speech in a distinguishing computer-generated voice for the author of the text section.
